(19) United States
(12) Patent Application Publication
(10) Pub. No.: US 2016/0365088 A1
(43) Pub. Date: Dec. 15, 2016

(54) VOICE COMMAND RESPONSE ACCURACY

(71) Applicant: SYNAPSE.AI INC., Palo Alto, CA (US)

(72) Inventors: Tao LIANG, Palo Alto, CA (US); Mehul PATEL, Saratoga, CA (US); Hitesh CHHATRALA, Mountain View, CA (US); Todd BILSBORROW, Sunnyvale, CA (US)

(73) Assignee: SYNAPSE.AI INC., Palo Alto, CA (US)

(21) Appl. No.: 15/179,277

(22) Filed: Jun. 10, 2016

Related U.S. Application Data
(60) Provisional application No. 62/173,765, filed on Jun. 10, 2015.

(51) Int. Cl. G10L 15/01; G06F 3/01; G06F 3/0484

(52) U.S. Cl. CPC G10L 15/01; G06F 3/04842; G06F 3/016; G10L 2015/225

(57) ABSTRACT

According to an example, a processor may receive a request via voice command and obtain a response to the request. The processor may also obtain a confidence level of the obtained response, in which the confidence level corresponds to an accuracy of the identified response to the received request, identify an indication aspect corresponding to the identified confidence level, wherein different indication aspects correspond to different confidence levels, and output the obtained response with the identified indication aspect. The processor may also receive user feedback on the outputted response, in which the received user feedback is used to improve an accuracy of responses provided by the processor to requests received via voice command.

### CLAIM FOR PRIORITY

This application claims the benefit of priority to U.S. Provisional Application Ser. No. 62/173,765, filed on Jun. 10, 2015, the disclosure of which is hereby incorporated by reference in its entirety.

### BACKGROUND

The use of voice commands to interface with computing devices have steadily increased over the years. Unlike typing, cursor, and touch interfaces, however, voice interfaces are not accurate to the point that humans have full control of the intended outcomes of their commands. This inaccuracy may be an inherent part of the speech recognition technology, or may be caused by various other influencing factors (e.g., background noise, voice levels, human accents and other speech characteristics), many of which are common and unavoidable. When managed poorly, unexpected or unwanted outcomes that happen as a result of this inaccuracy end up eroding the user's trust in applications that use voice interfaces.

### BRIEF DESCRIPTION OF THE DRAWINGS

Features of the present disclosure are illustrated by way of example and not limited in the following figure(s), in which like numerals indicate like elements, in which:

FIG. 1 shows a simplified block diagram of a computing device on which various features of the methods disclosed herein may be implemented according to an example of the present disclosure;

FIG. 2 shows a flow chart of a method for improving voice command response accuracy according to an example of the present disclosure;

FIGS. 3A-3C, respectively, show examples of how different background colors may be used to indicate different values of an indicator based upon a confidence score, according to an example of the present disclosure; and

FIG. 4 depicts a simplified block diagram of a computing device on which various features of the methods disclosed herein may be implemented according to another example of the present disclosure;.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

A number of algorithms may be employed in the speech recognition and response processes. In modern technologies, these algorithms and their computations may be performed on servers (e.g., in the Cloud), on the local computational device (e.g., laptops, mobile devices), or a combination thereof. When applicable, these algorithms may have a measurement of confidence. This algorithmic confidence, often referred to as confidence level, confidence score, or simply confidence, is a measurement of the probability of accuracy of the outcome. When multiple algorithms are involved, confidence scores of those algorithms may be rolled up into a single overall confidence score. This confidence score is an indicator of the likelihood of the machine produced outcome matching the expected outcome from the user.

Disclosed herein are computing devices, methods for implementing the computing devices, and a computer readable medium on which is stored instructions corresponding to the methods. Particularly, the methods disclosed herein may improve the accuracy of voice command responses by, for instance, improving the training of machine learning algorithms used in speech recognition and response processing applications. Generally speaking, machine learning algorithms may rely on statistical calculations, or neural networks, which are analogous to how human brains work. The accuracies of the machine learning algorithms, and thus algorithmic confidences, may benefit from the user feedback discussed in the present disclosure. In essence, and as discussed in detail herein, through feedback, the user may “teach” the machine learning algorithms what the machine learning algorithms concluded accurately (and thus should repeat next time), and what the machine learning algorithms didn't conclude accurately (and thus should not repeat next time).

According to an example, the methods disclosed herein may tie an algorithmic confidence score to a number of user interface elements to show this confidence score in a subtle and intuitive manner, such that a user may carry on normal interactions while having contextual awareness of the accuracy performance of the application. This may be analogous to watching someone's body language while carrying on a conversation with them. Furthermore, through implementation of the methods disclosed herein, a user may leverage such contextual awareness and when appropriate, provide direct feedback to improve future accuracy performance.

In addition, through implementation of the methods disclosed herein, algorithmic confidence levels may be indicated without being intrusive or disruptive to normal user interactions. Moreover, a user may leverage the awareness that the user gains to allow them to provide better feedback and thus enhance training of the machine learning algorithms. The methods disclosed herein may be useful for applications that utilize machine learning techniques, and may be most applicable to voice applications on mobile devices. In one regard, through use of the methods disclosed herein, the amount of time required to train the algorithms, which may be machine-learning algorithms used in speech recognition and response applications, may significantly be reduced or minimized as compared with other manners of training the algorithms. The reduction in time may also result in a lower processing power and the use of less memory by a processor in a computing device that executes the machine-learning algorithms.

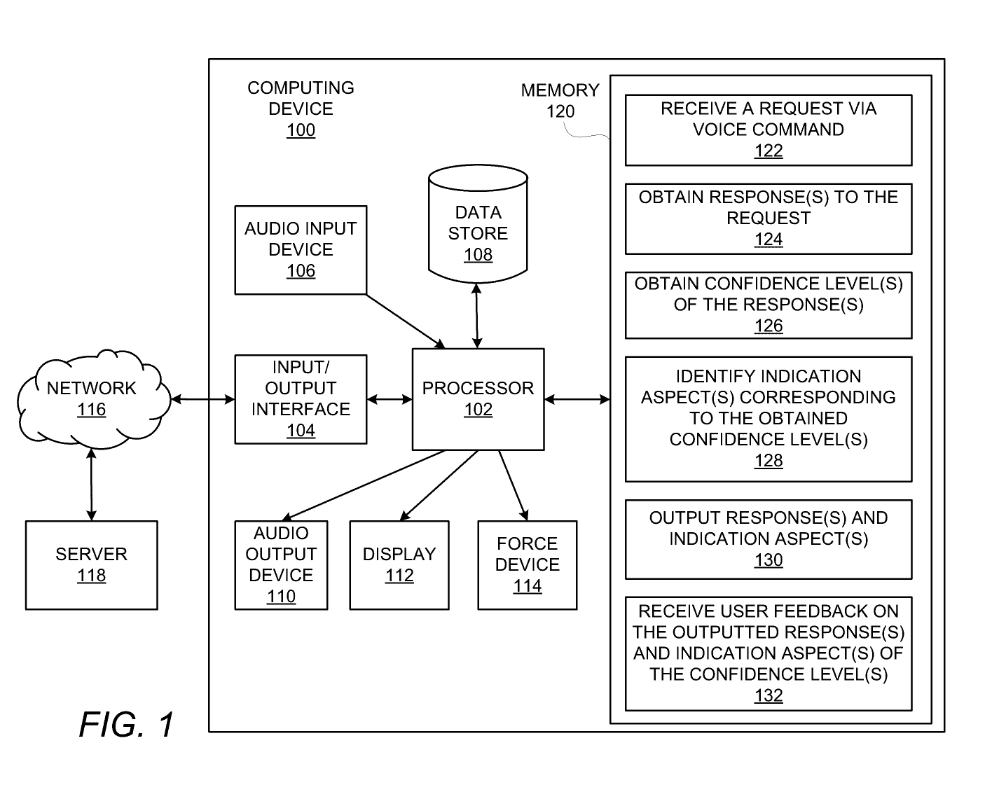

With reference first to FIG. 1, there is shown a simplified block diagram of a computing device 100 on which various features of the methods disclosed herein may be implemented according to an example of the present disclosure. It should be understood that the computing device 100 depicted in FIG. 1 may include additional components and that some of the components described herein may be removed and/or modified without departing from a scope of the computing device 100 disclosed herein.

The computing device 100 may be a mobile computing device, such as a smartphone, a tablet computer, a laptop computer, a cellular telephone, a personal digital assistant, or the like. As shown, the computing device 100 may include a processor 102, an input/output interface 104, an audio input device 106, a data store 108, an audio output device 110, a display 112, a force device 114, and a memory 120. The processor 102 may be a semiconductor-based microprocessor, a central processing unit (CPU), an application specific integrated circuit (ASIC), and/or other hardware device. The processor 102 may communicate with a server 118 through a network 116, which may be a cellular network, a Wi-Fi network, the Internet, etc. The memory 120, which may be a non-transitory computer readable medium, is also depicted as including instructions to receive a request via voice command 122, obtain response(s) to the request 124, obtain confidence level(s) of the response(s) 126, identify indication aspect(s) corresponding to the obtained confidence level(s) 128, output response(s) and indication aspect(s) 130, and receive user feedback on the outputted response(s) and indication aspect(s) of the confidence level(s) 132.

The processor 102 may implement or execute the instructions 122-132 to receive a request via voice command through the audio input device 106. In an example, the processor 102 is to obtain the response(s) to the request through implementation of an algorithm stored in the data store 108 that is to determine the response to the request. In this example, the processor 102 may also obtain the confidence level(s) of the response(s) during determination of the response(s).

In another example, the processor 102 is to communicate the received request through the input/output interface 104 to the server 118 via the network 116. In this example, the server 118 is to implement an algorithm to determine the response(s) to the request and the confidence level(s) of the determined response(s). As such, the processor 102 in this example is to obtain the response(s) and the confidence level(s) from the server 118.

In an example, the processor 102 is to identify the indication aspect(s) corresponding to the obtained confidence level(s) from, for instance, a previously stored correlation between confidence levels and indication aspects. The previously stored correlation between the confidence levels and the indication aspects may have been user-defined. In another example, the server 118 is to identify the indication aspect(s) corresponding to the obtained confidence level(s) from, for instance, a previously stored correlation between confidence levels and indication aspects.

In any of the examples above, the processor 102 may output the response(s) and indication aspect(s) through at least one of the audio output device 110, the display 112, and the force device 114. For instance, the processor 102 may output the response(s) visually through the display 112 and any output the indication aspect(s) as a background color on the display 112. As another example, the processor 102 may output the response(s) audibly through the audio output device 110 and may also output the indication aspect(s) as a sound through the audio output device 100. As a further example, the processor 102 may output the response(s) visually through the display 112 and may output the indication aspect(s) as a vibration caused by the force device 114.

The processor 102 may also receive user feedback on the outputted response(s) and the indication aspect(s, for instance, through the audio input device 102. For instance, the user feedback may indicate the confidence level the user has in the outputted response(s), i.e., to reinforce or correct the confidence level(s) corresponding to the outputted response(s). This user feedback may be employed to train algorithms employed in speech recognition and response processes.

The data store 108 and the memory 120 may each be a computer readable storage medium, which may be any electronic, magnetic, optical, or other physical storage device that contains or stores executable instructions. Thus, the data store 108 and/or the memory 120 may be, for example, Random Access Memory (RAM), an Electrically Erasable Programmable Read-Only Memory (EEPROM), a storage device, an optical disc, and the like. Either or both of the data store 108 and the memory 120 may be a non-transitory computer readable storage medium, where the term “non-transitory” does not encompass transitory propagating signals.

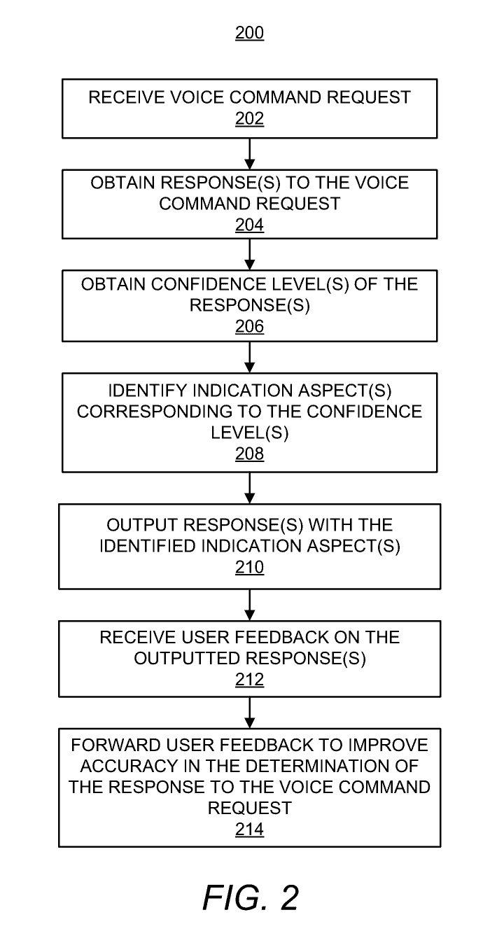

Various manners in which the computing device 100 may be implemented are discussed in greater detail with respect to the method 200 depicted in FIG. 2. Particularly, FIG. 2 depicts a flow chart of a method 200 for improving voice command response accuracy according to an example of the present disclosure. It should be apparent to those of ordinary skill in the art that the method 200 may represent a generalized illustration and that other operations may be added or existing operations may be removed, modified, or rearranged without departing from the scope of the method 200.

The description of the method 200 is made with reference to the computing device 100 illustrated in FIG. 1 for purposes of illustration. It should, however, be clearly understood that computing devices having other configurations may be implemented to perform the method 200 without departing from the scope of the method 200.

At block 202, the processor 102 may execute the instructions 122 to receive a request via voice command. For instance, the processor 102 may receive the request via the audio input device 106 and may store the received voice command in the data store 108.

At block 204, the processor 102 may execute the instructions 124 to obtain at least one response to the received voice command request. The processor 102 may execute multiple sub-steps at blocks 202 and 204. For instance, the processor 102 may calculate confidence levels at each of the multiple sub-steps while the obtained response is being calculated. In other words, the processor 102 may use confidence levels of sub-responses or candidate responses as a part of the obtained response calculation.

At block 206, the processor 102 may execute the instructions 126 to obtain confidence level(s) of the obtained response(s). For instance, the processor 102 may obtain confidence level(s) that are the confidence levels of the sub-responses or candidate responses or a single confidence level that is a combination of the confidence levels of the sub-responses or candidate responses. The confidence level of a response, sub-response, or candidate response may be defined as a confidence level of the accuracy of the identified response, sub-response, or candidate response to the received request.

At block 208, the processor 102 may execute the instructions 128 to identify at least one indication aspect corresponding to the confidence level(s) obtained at block 206. The indication aspect may be defined as an aspect of an indication that corresponds to a confidence level, in which different confidence levels correspond to different indication aspects. The indication aspects may include different values of an indicator, e.g., different background colors, different gradients, etc. Thus, different confidence levels may correspond to the same color, but may correspond to different shades of the same color. As another example, the indication aspects may be different sounds or sound characteristics.

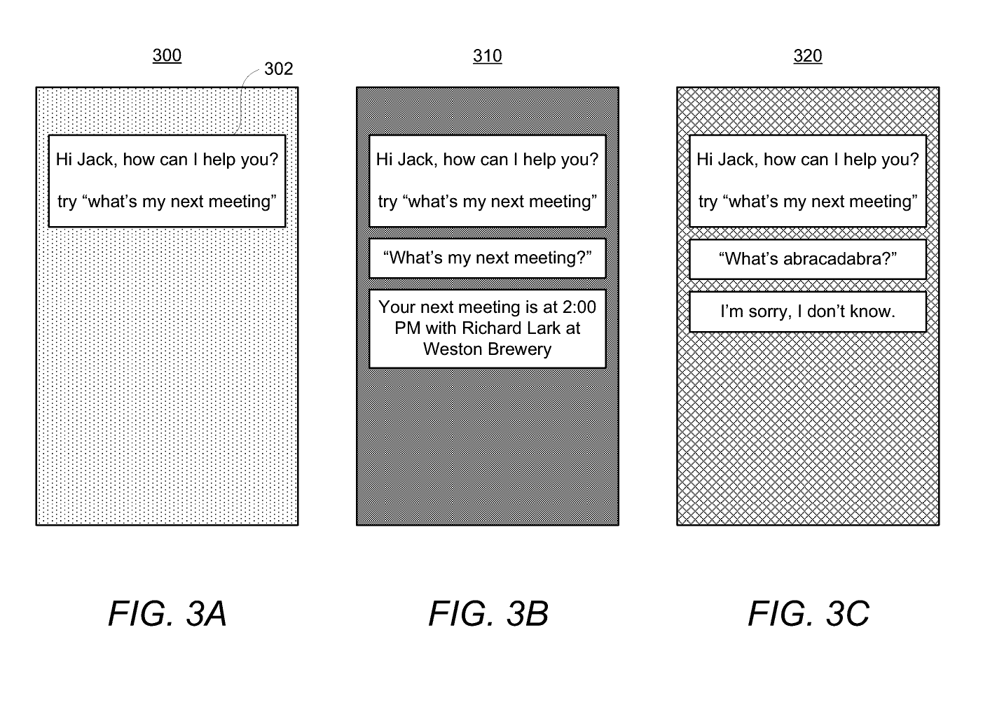

Turning now to FIGS. 3A-3C, there are respectively shown examples 310-320 of how different background colors may be used to indicate different values of an indicator based upon a confidence score. FIGS. 3A-3C, respectively, depict example screenshots of a user's interaction with a mobile device, which may be an example of a computing device 100 depicted in FIG. 1. In these examples, the foreground objects 302 may be “cards” that represent the users' spoken commands and the graphical portion of the processor's 102 response. While the user may focus on the voice interaction, and even the foreground objects 302, the colors in the background may non-intrusively project the confidence levels of the processor 102, without disrupting a normal sequence of interaction. Particularly, FIG. 3A may depict a background color that represents a normal confidence level, FIG. 3B may depict a background color that represents a high confidence level, and FIG. 3C may depict a background color that represents a low confidence level.

The thresholds for high, normal, and low confidence might vary based on the interactions, the algorithms, the use cases, and even the users themselves. In addition, there may not be a need to clearly delineate those thresholds. A user may register different levels based on their own interpretations. In an example in which red represents low confidence and purple represents normal confidence, colors between purple and red may represent varying levels of low to normal confidence levels. Furthermore, these colors may be user-configurable. That is, some users may prefer to have the color red represent high confidence while other users may change the colors due to color vision deficiencies.

Similar to background color, various background gradients may be used to graphically indicate confidence levels. Examples of variations may include direction of gradient, gradualness of change, patterns of gradient (otherwise known as the gradient function).

It should be understood that the above-described background color and gradient designs are only examples of such indication aspects and that other indications aspects may be additionally or alternatively be implemented. The indication aspects may be used in conjunction with each other or independently. In addition, the indications aspects may have their own corresponding set of user configurable settings as appropriate. The following is a list of additional indication aspects that may be implemented in the present disclosure:

1. background color, gradient, pattern, and pictures
2. voice utterances, including hesitation, etc.
3. voice characteristics such as speed, pitch, modulation, etc.
4. other user interface elements such as motion, vibration, and force feedback.

With reference back to FIG. 2, at block 210, the processor 102 may execute the instructions 130 to output the obtained response(s) with the identified indication aspect(s). The processor 102 may output the obtained response(s) by, for instance, displaying the obtained response(s) and the identified indication aspect(s) on the display 112, communicating the obtained response(s) to another computing device through the network 116, audibly outputting the obtained response and identified indication aspect from the audio output device 110, causing the force device 114 to vibrate, etc. For instance, the processor 102 may display the obtained response(s) and may vary the background color of the display according to the identified indication aspect(s). As another example, the processor 102 may audibly output the obtained response(s) and may vary a characteristic of the audible output, e.g., a tone denoting a confidence level, depending upon the identified indication aspect(s).

At block 212, the processor 102 may execute the instructions 132 to receive user feedback on the outputted response(s). For instance, a user may provide feedback as to the perceived accuracy of the outputted response(s). The user feedback may be in the form of a voice input to indicate whether the outputted response(s) is correct or not. As another example, the user feedback may indicate the confidence measure the user has in the outputted response, e.g., to reinforce or correct the confidence level(s) corresponding to the outputted response(s).

The user feedback may be used to train algorithms employed in speech recognition and response processes. In one regard, through use of the method 200, the amount of time required to train the algorithms, which may be machine-learning algorithms, may significantly be reduced or minimized as compared with other manners of training the algorithms. The reduction in time may also result in a lower processing power and the use of less memory in the computing device 100.

By giving a user an awareness of the algorithmic confidence, the user is enabled to not only provide feedback on the accuracy of the outcome, but to also provide feedback on the algorithms' confidence level. For example, in a normal feedback scenario, given a voice input, and a response, the user may provide feedback such as “yes, that's correct” or “no, that's incorrect.” Because the feedback is purely based on the response, the feedback is bi-modal as explained in the above examples.

However, through implementation of the computing device 100 and method 200 disclosed herein, the user may provide feedback not only on the correctness of the response, but also on the confidence level. For example, when a response is produced with relatively low confidence, the user may reinforce that confidence level by saying “I'm also not sure that's correct.” Alternatively, the user may correct that low confidence level by saying “I'm very sure that's correct.” In both cases, the response is seen as correct by the user. However, the feedback incorporates how confident the user is about the correctness of the response. In one regard, therefore, a user may be able to compare their own confidence level with the algorithmic confidence level and reinforce when they match and correct when they are different.

The enriched feedback mechanism afforded through implementation of the computing device 100 and method 200 disclosed herein may make training of the machine learning algorithms used in speech recognition and response processing applications more efficient. For instance, machine learning algorithms that use speech recognition and response processing applications may be trained using fewer feedback action from a user, less processing power (i.e., less CPU cycles), less memory for training data, less time to training the algorithms, etc.

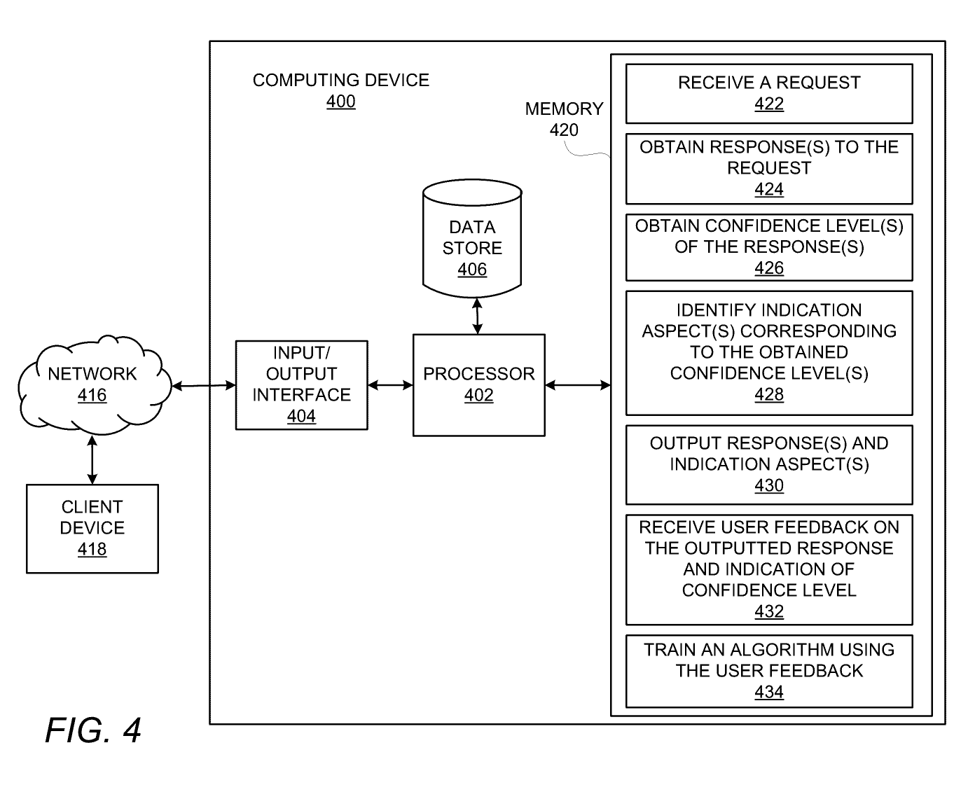

According to another example, the method 200 may be implemented or executed by a computing device 400 as shown in FIG. 4. The computing device 400 may be a computer system, a server, etc. As shown, the computing device 400 may include a processor 402, an input/output interface 404, a data store 406, and a memory 420. The processor 402 may be a semiconductor-based microprocessor, a central processing unit (CPU), an application specific integrated circuit (ASIC), and/or other hardware device. The processor 402 may communicate with a client device 418 through a network 416, which may be a cellular network, a Wi-Fi network, the Internet, etc. The client device 418 may be the computing device 100 depicted in FIG. 1. The memory 420, which may be a non-transitory computer readable medium, is also depicted as including instructions to receive a request 422, obtain response(s) to the request 424, obtain confidence level(s) of the response(s) 426, identify indication aspect(s) corresponding to the obtained confidence level(s) 428, output response(s) and indication aspect(s) 430, receive user feedback on the outputted response(s) and indication aspect(s) of the confidence level(s) 432, and train an algorithm using the user feedback 434.

The processor 402 may implement or execute the instructions 422-434 to receive a request from the client device 418 through the input/output interface 404 via the network 416. The processor 402 may execute the instructions 424 to implement an algorithm to determine the response(s) to the request and the confidence level(s) of the determined response(s). As such, the processor 402 in this example may execute the instructions 426 to obtain the response(s) and the confidence level(s) by determining the response(s) and the confidence level(s). The processor 402 may execute the instructions 428 to identify the indication aspect(s) corresponding to the obtained confidence level(s) from, for instance, a previously stored correlation between confidence levels and indication aspects. The processor 402 may also execute the instructions 430 output the response(s) and the indication aspect(s) to the client device 418.

In another example, the client device 418 may identify the indication aspect(s) corresponding to the obtained confidence level(s) from, for instance, a previously stored correlation between confidence levels and indication aspects. In this example, the processor 402 may output the obtained response(s) and the confidence level(s) to the client device 418 without outputting an indication aspect(s).

The processor 402 may receive user feedback on the outputted response(s) and the indication aspect(s), for instance, from the client device 418. As discussed above, the user feedback may indicate the confidence level the user has in the outputted response(s), i.e., to reinforce or correct the confidence level(s) corresponding to the outputted response(s). The processor 402 may also execute the instructions 434 to train a machine learning algorithm employed in speech recognition and response processes using the received user feedback.

Either or both of the data store 406 and the memory 420 may be non-transitory computer readable storage mediums, which may be any electronic, magnetic, optical, or other physical storage device that contains or stores executable instructions. Thus, the data store 406 and the memory 420 may each be, for example, Random Access Memory (RAM), an Electrically Erasable Programmable Read-Only Memory (EEPROM), a storage device, an optical disc, and the like. In some implementations, the data store 406 and the memory 420 may each be a non-transitory computer readable storage medium, where the term “non-transitory” does not encompass transitory propagating signals.

Some or all of the operations set forth in the method 200 and the instructions 422-434 contained in the memory 420 may be contained as utilities, programs, or subprograms, in any desired computer accessible medium. In addition, the method 200 and the instructions 422-434 may be embodied by computer programs, which may exist in a variety of forms both active and inactive. For example, they may exist as machine readable instructions, including source code, object code, executable code or other formats. Any of the above may be embodied on a non-transitory computer readable storage medium. Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure. What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A computing device for improving voice command response accuracy, said computing device comprising:
a processor;
a memory on which is stored machine readable instructions that are to cause the processor to:
receive a request via voice command;
obtain a response to the request;
obtain a confidence level of the obtained response, wherein the confidence level corresponds to an accuracy of the identified response to the received request;
identify an indication aspect corresponding to the identified confidence level, wherein different indication aspects correspond to different confidence levels;
output the obtained response with the identified indication aspect; and
receive user feedback on the outputted response, wherein the received user feedback is used to improve an accuracy of responses provided by the processor to requests received via voice command.

2. The computing device according to claim 1, wherein the machine readable instructions are further to cause the processor to:
implement the received user feedback to improve the accuracy of responses to requests received via voice command.

3. The computing device according to claim 1, wherein the machine readable instructions are further to cause the processor to:
communicate the received user feedback to a server, and wherein the server is to implement the received user feedback to improve the accuracy of responses to requests received via voice command.

4. The computing device according to claim 1, wherein, to obtain the response to the request, the machine readable instructions are further to cause the processor to:
identify a plurality of candidate responses to the request; and
identify a confidence level of each of the plurality of candidate responses, wherein the obtained response corresponds to the candidate response of the plurality of candidate responses having the highest confidence level.

5. The computing device according to claim 1, wherein, to obtain the response to the request, the machine readable instructions are further to cause the processor to:
identify a plurality of sub-responses to the request; and
identify a confidence level of each of the plurality of sub-responses, wherein the obtained response is a combination of the identified confidence levels of the plurality of sub-responses.

6. The computing device according to claim 1, wherein the user feedback indicates a confidence measure the user has in the outputted response.

7. The computing device according to claim 6, further comprising:
an audio input device, wherein the user feedback is received as an audible input through the audio input device.

8. The computing device according to claim 1, wherein the different indication aspects includes different values of an indicator, and wherein the different values include at least one of different colors, different shades of a same color, and combinations thereof.

9. The computing device according to claim 1, wherein to output the obtained response with the identified indication aspect, the instructions are further to cause the processor to:
at least one of:
display the obtained response and the identified indication aspect on a display screen;
audibly output the obtained response and the identified indication aspect; and
mechanically output the identification indication as a vibration.

10. A method for improving voice command response accuracy comprising:
receiving, by a processor, a request via voice command;
obtaining, by the processor, a response to the request;
obtaining, by the processor, a confidence level of the obtained response, wherein the confidence level corresponds to an accuracy of the identified response to the received request;
identifying, by the processor, an indication aspect corresponding to the identified confidence level, wherein different indication aspects correspond to different confidence levels;
outputting, by the processor, the identified response with the identified indication aspect; and
receiving, by the processor, user feedback on the outputted response and the identified indication aspect, wherein the received user feedback indicates a confidence measure the user has in the outputted response.

11. The method according to claim 10, further comprising:
implementing the received user feedback to improve the accuracy of responses to requests received via voice command.

12. The method according to claim 10, further comprising:
communicating the received user feedback to a server, and wherein the server is to implement the received user feedback to improve the accuracy of responses to requests received via voice command.

13. The method according to claim 10, wherein obtaining the response to the request further comprises:
identifying a plurality of candidate responses to the request; and
identifying a confidence level of each of the plurality of candidate responses, wherein the obtained response corresponds to the candidate response of the plurality of candidate responses having the highest confidence level.

14. The method according to claim 10, wherein obtaining the response to the request further comprises:
identifying a plurality of sub-responses to the request; and
identifying a confidence level of each of the plurality of sub-responses, wherein the obtained response is a combination of the identified confidence levels of the plurality of sub-responses.

15. The method according to claim 10, wherein the different indication aspects includes different values of an indicator, and wherein the different values include at least one of different colors, different shades of a same color, and combinations thereof.

16. The method according to claim 10, wherein outputting the obtained response with the identified indication aspect further comprises:
at least one of:
displaying the obtained response and the identified indication aspect on a display screen;
audibly outputting the obtained response and the identified indication aspect; and
mechanically outputting the identification indication as a vibration.

17. A non-transitory computer readable storage medium on which is stored machine readable instructions that when executed by a processor cause the processor to:
receive a request via voice command;
obtain a response to the request;
obtain a confidence level of the obtained response, wherein the confidence level corresponds to an accuracy of the identified response to the received request;
identify an indication aspect corresponding to the identified confidence level, wherein different indication aspects correspond to different confidence levels;
output the identified response with the identified indication aspect; and
receive user feedback on the outputted response and the identified indication aspect, wherein the received user feedback indicates a confidence measure the user has in the outputted response.

18. The non-transitory computer readable storage medium according to claim 17, wherein the machine readable instructions are further to cause the processor to:
implement the received user feedback to improve the accuracy of responses to requests received via voice command.

19. The non-transitory computer readable storage medium according to claim 17, wherein the machine readable instructions are further to cause the processor to:
identify a plurality of candidate responses to the request; and
identify a confidence level of each of the plurality of candidate responses, wherein the obtained response corresponds to the candidate response of the plurality of candidate responses having the highest confidence level.

20. The non-transitory computer readable storage medium according to claim 17, wherein the machine readable instructions are further to cause the processor to:
identify a plurality of sub-responses to the request; and
identify a confidence level of each of the plurality of sub-responses, wherein the obtained response is a combination of the identified confidence levels of the plurality of sub-responses.
